(19) United States
(12) Patent Application Publication
(10) Pub. No.: US 2006/0084709 A1
(43) Pub. Date: Apr. 20, 2006

(54) High-temperature rigid polyurethane spray foam for pipe insulation

(75) Inventor: Michael A. Dobransky, Pittsburgh, PA (US)

Correspondence Address: BAYER MATERIAL SCIENCE LLC, 100 BAYER ROAD, PITTSBURGH, PA, 15205, US

(73) Assignee: Bayer MaterialScience LLC

(21) Appl. No.: 10/965,352

(22) Filed: Oct. 14, 2004

(51) Int. Cl. C08G 18/48; C08J 9/00

(52) U.S. Cl. 521/131

(57) ABSTRACT

The present invention provides a rigid polyurethane spray foam, which is made using cyclopentane as the blowing agent and which is useful for pipe insulation because of its ability to withstand high-temperatures (>250° F.). The inventive foams may be sprayed with existing foam spraying equipment because the foams are reacted at about a 1:1.25 polyol to isocyanate ratio.

### FIELD OF THE INVENTION

The present invention relates in general to rigid polyurethanes, and more specifically, to high-temperature (>250° F.) rigid polyurethane spray foams using cyclopentane as the blowing agent. Such foams are particularly suitable as pipe insulation.

### BACKGROUND OF THE INVENTION

Manufacturers of insulated pipe in North America have traditionally used materials such as asbestos, calcium silicate, mineral wool and fiberglass to insulate pipes carrying materials at temperatures above 250° F. The insulating material is usually wrapped around and secured to the pipe.

Rigid polyurethane foam makes an excellent pipe insulating material and can be molded around a pipe, cut from bun stock and secured to a pipe, or sprayed on a rotating pipe. Rigid polyurethane foam has been used to insulate district-heating pipes in Europe since the early 1960's. Polyurethane insulated pipes are also used in chemical plants for liquid transmission. These applications typically require that the insulating material withstand continuous operating temperatures of about 250-350° F. (121-177° C.).

Rigid polyurethane foam, as an insulator, typically has a maximum operating temperature of about 250° F. European Standard EN 253 was adopted to predict the service life of an insulated pipe at a specified operating temperature. This standard defines specific tests and provides minimum requirements for polyurethane foam insulating materials. The service life at a specified operating temperature is estimated from axial and tangential shear tests of a pipe insulating material at elevated temperatures, over a period of time, i.e., 160° C. for 3,600 hours or at 170° C. for 1,450 hrs. An Arrhenius relation is developed using the results of the shear tests and used to predict the service life of the insulating material at a specific temperature. The United States does not have a comparable standard certification test. Therefore, polyurethane insulated pipe manufacturers must rely on the polyurethane foam suppliers to assure performance of the polyurethane foam at a specified temperature.

Chlorofluorocarbons (CFCs), hydrochlorofluorocarbons (HCFCs) and water have been the preferred blowing agents used in making rigid polyurethane foams. However, the United States Environmental Protection Agency (EPA) has banned the use of CFCs and has limited the production and use of HCFCs. Some of the alternative blowing agents are hydrofluorocarbons (HFCs), water and hydrocarbons.

Spray foam systems using a combination of HFC-245fa and water have been developed. However, many existing spray foam machines operate at fixed 1:1 or 1:1.25 by volume ratio of polyol to isocyanate (B/A), thus limiting the use of water as a blowing agent. Cyclopentane has a zero Ozone Depletion Potential (ODP), low vapor thermal conductivity (0.012 W/mK @ 25° C.), and boiling point of 49.3° C. suggesting it as a viable blowing agent for rigid polyurethane spray foams.

A number of artisans have attempted to provide polyurethane foams which will function as pipe insulators.

U.S. Pat. No. 6,281,393, issued to Molina et al., teaches Mannich polyols having a viscosity of from 300 to 3,500 cps (0.3 to 3.5 Pa·s) at 25° C. prepared by admixing a phenol, an alkanolamines, and formaldehyde in molar ratios of from 1:1:1 to 1:2.2:2.2 resulting in an initiator which can be alkoxylated using a mixture of ethylene oxide and propylene oxide to prepare polyols that have a nominal functionality of from 3 to 5.4. Molina et al. state that one area of use for such polyols has been in spray foams systems used in roof and pipe insulation applications. Preferred blowing agents to be used with water are HCFC-141b, HCFC-22, HFC-134a, n-pentane, isopentane, cyclopentane, HCFC-124 and HFC-245.

Snider et al., in U.S. Pat. No. 5,064,873, teach rigid cellular polymers made by reacting an isocyanate-terminated quasi-prepolymer with a polyol component comprising a polyester polyol having a free glycol content of less than about 7 percent by weight of the polyester polyol in the presence of a blowing agent. The combined use of the quasi-prepolymer and the polyester polyol is said to enhance the thermal insulating properties of the foams. The foam materials of Snider et al. are stated to be useful, with or without a facer(s), for pipe insulation.

U.S. Pat. No. 5,895,792 issued to Rotermund et al., discloses a process for producing rigid polyurethane foams having improved heat distortion resistance and reduced thermal conductivity by reacting a) polyisocyanates with b) compounds containing hydrogen atoms reactive toward isocyanates, in the presence of c) water, and, if desired, d) physically acting blowing agents and e) catalysts and known auxiliaries and/or additives, the compounds b) containing hydrogen atoms reactive toward isocyanates are a polyol mixture comprising b1) a polyol which can be prepared by addition of ethylene oxide and/or propylene oxide onto a hexitol or a hexitol mixture, with the total hexitol content of the polyol mixture being from 15 to 30% by weight, based on the polyol mixture, and b2) a polyol which can be prepared by addition of ethylene oxide and/or propylene oxide onto one or more aromatic amines, with the total amine content of the polyol mixture being from 1 to 10% by weight, based on the polyol mixture, and the amount of the polyol mixture in the component b) is from 60 to 100 parts by mass per 100 parts by mass of the component b). The process disclosed in the Rotermund et al. patent is said to provide rigid polyurethane foams for use in plastic-sheathed pipes. The foams are said to have a low thermal conductivity and a high heat distortion resistance at high temperatures, can be produced without the use of halogenated hydrocarbons and display low chemical degradation. However, the hexitol-based foams of Roetemund et al. are not reacted at a 1:1.25 volume ratio nor are those foams stated to be sprayable.

Morton et al., in “Global opportunities in Pipe in Pipe technology”, presented at UTECH 2003 (Mar. 25-27, 2003), disclose a modified polyisocyanurate polyurethane foam with high temperature resistance which is said to be useful in producing industrial preinsulated pipes. The polyurethane foams of Morton et al. are stated to have robust processability in continuous production as well as in conventional discontinuous process. Further, the initial thermal resistance and preliminary ageing studies at high temperatures are said to point to a calculated continuous operating temperature higher than 172° C. over a period of 10 years. The foams of Morton et al. are not reacted at a 1:1.25 volume ratio.

Therefore, a need exists in the art for rigid polyurethane spray foams for pipe insulation using cyclopentane as the blowing agent which are able to withstand high-temperatures (>250° F.) and which are able to be sprayed in existing foam spraying equipment at about a 1:1.25 polyol to isocyanate ratio.

### SUMMARY OF THE INVENTION

Accordingly, the present invention provides such rigid polyurethane spray foams, which use cyclopentane as the blowing agent and are useful for pipe insulation because of their ability to withstand high-temperatures (>250° F.). The inventive foams may use existing foam spraying equipment because the foams are reacted at about a 1:1.25 polyol to isocyanate ratio. These and other advantages and benefits of the present invention will be apparent from the Detailed Description of the Invention herein below.

### DETAILED DESCRIPTION OF THE INVENTION

The present invention will now be described for purposes of illustration and not limitation. Except in the operating examples, or where otherwise indicated, all numbers expressing quantities, percentages, OH numbers, functionalities and so forth in the specification are to be understood as being modified in all instances by the term “about.” Equivalent weights and molecular weights given herein in Daltons (Da) are number average equivalent weights and number average molecular weights respectively, unless indicated otherwise.

The rigid polyurethane foam of the present invention is the reaction product of a polyol component comprising 70% to 40% by weight, based on the weight of the polyol component, of at least one polyether polyol, and 30% to 60% by weight, based on the weight of the polyol component, of at least one polyester polyol having an OH number of less than 350 mg KOH/g with at least one isocyanate, at a polyol component to isocyanate ratio of 1:1.25 by volume, in the presence of a blowing agent chosen from n-pentane, isopentane and cyclopentane, and optionally, in the presence of at least one of catalysts, fillers, additives and surfactants, wherein the rigid polyurethane foam has a cross linking density of less than 2.6.

The present invention further provides a process for making a rigid polyurethane foam involving reacting a polyol component comprising 70% to 40% by weight, based on the weight of the polyol component, of at least one polyether polyol, and 30% to 60% by weight, based on the weight of the polyol component, of at least one polyester polyol having an OH number of less than 350 mg KOH/g with at least one isocyanate, at a polyol component to isocyanate ratio of 1:1.25 by volume, in the presence of a blowing agent chosen from n-pentane, isopentane and cyclopentane, and optionally, in the presence of at least one of catalysts, fillers, additives and surfactants, wherein the rigid polyurethane foam has a cross linking density of less than 2.6.

The present invention yet further provides a process for insulating a pipe involving spraying onto the pipe a rigid polyurethane foam comprising the reaction product of a polyol component comprising 70% to 40% by weight, based on the weight of the polyol component, of at least one polyether polyol, and 30% to 60% by weight, based on the weight of the polyol component, of at least one polyester polyol having an OH number of less than 350 mg KOH/g with at least one isocyanate, at a polyol component to isocyanate ratio of 1:1.25 by volume, in the presence of a blowing agent chosen from n-pentane, isopentane and cyclopentane, and optionally, in the presence of at least one of catalysts, fillers, additives and surfactants, wherein the rigid polyurethane foam has a cross linking density of less than 2.6.

In the manufacture of rigid foams according to the present invention, two preformulated components may be used, commonly called the A-component (also called the A-side) and the B-component (or B-side). Typically, the A-component contains the isocyanate compound which is reacted with the polyol containing B-component to form the foam, with the remainder of the foam-forming ingredients distributed in these two components or in yet another component or components.

Any organic polyisocyanate can be employed in the preparation of the rigid foams according to the present invention including aromatic, aliphatic and cycloaliphatic polyisocyanates and combinations thereof. Suitable polyisocyanates are described, for example, in U.S. Pat. Nos. 4,795,763, 4,065,410, 3,401,180, 3,454,606, 3,152,162, 3,492,330, 3,001,973, 3,394,164 and 3,124,605, the entire contents of which are incorporated herein by reference thereto.

Examples of such polyisocyanates are the diisocyanates such as m-phenylene diisocyanate, toluene-2,4-diisocyanate, toluene-2,6-diisocyanate, mixtures of 2,4- and 2,6-toluene diisocyanate, hexamethylene-1,6-diisocyanate, tetramethylene-1,4-diisocyanate, cyclohexane-1,4-diisocyanate, hexahydrotoluene 2,4- and 2,6-diisocyanate, naphthalene-1,5-diisocyanate, 4,4′-diphenylmethane diisocyanate (MDI), polymeric MDI (PMDI), 4,4′-diphenylenediisocyanate, 3,3′-dimethoxy-4,4′-biphenyl-diisocyanate, 3,3′-dimethyldiphenylmethane-4,4′-diisocyanate; the triisocyanates such as 4,4′,4′-triphenylmethane-triisocyanate, polymethylenepolyphenyl isocyanate, toluene-2,4,6-triisocyanate; and the tetraisocyanates such as 4,4′-dimethyldiphenylmethane-2,2′,5,5′-tetraisocyanate.

Prepolymers may also be employed in the preparation of the foams of the present invention. Prepolymers may be prepared by reacting an excess of organic polyisocyanate or mixtures thereof with a minor amount of an active hydrogen-containing compound as determined by the well-known Zerewitinoff test, as described by Kohler in “Journal of the American Chemical Society,” 49, 3181(1927). These compounds and their methods of preparation are well known in the art. The use of any one specific active hydrogen compound is not critical, any such compound can be employed in the practice of the present invention.

A particularly preferred isocyanate for inclusion in the foams of the present invention is polymeric MDI (PMDI), or prepolymers of PMDI.

The use of polyurethane as an insulating material has heretofore been generally limited to applications with operating temperatures of less than 250° F. The incorporation of isocyanurate structure into the foam is known to increase thermal stability. However, many older spray foam machines operate at a fixed B/A by volume ratio of 1:1 or 1:1.25, therefore eliminating the possibility of formulating a high NCO/OH groups system to increase the trimer content of the foam. The properties of highly heat-resistant foams are, therefore, largely determined by the polyol component. It has been reported that a cross-link density of 2.6 will give a foam having a softening temperature of greater than 160° C. The cross-link density is dependent on the hydroxyl value and functionality of the polyols and the functionality of the isocyanate. The polyol component of the foams of the present invention is a polyol blend of at least one polyester polyol and at least one polyether polyol. The polyether polyol and the polyester polyol are present at in the blend at ratio of 70:30 to 40:60.

Polyether polyols useful in the present invention include the reaction products of a polyfunctional active hydrogen initiator and a monomeric unit such as ethylene oxide, propylene oxide, butylene oxide and mixtures thereof, preferably propylene oxide, ethylene oxide or mixed propylene oxide and ethylene oxide. The polyfunctional active hydrogen initiator preferably has a functionality of 2-8, and more preferably has a functionality of 3 or greater (e.g., 4-8).

A wide variety of initiators may be alkoxylated to form useful polyether polyols. Thus, for example, poly-functional amines and alcohols of the following type may be alkoxylated: monoethanolamine, diethanolamine, triethanolamine, ethylene glycol, polyethylene glycol, propylene glycol, hexanetriol, polypropylene glycol, glycerine, sorbitol, trimethylolpropane, pentaerythritol, sucrose and other carbohydrates. Particularly preferred are polyether polyols based on sucrose or sorbitol. Such amines or alcohols may be reacted with the alkylene oxide(s) using techniques known to those skilled in the art. The hydroxyl number which is desired for the finished polyol determines the amount of alkylene oxide used to react with the initiator. The polyether polyol may be prepared by reacting the initiator with a single alkylene oxide, or with two or more alkylene oxides added sequentially to give a block polymer chain, or at once to achieve a random distribution of such alkylene oxides. Polyol blends such as a mixture of high molecular weight polyether polyols with lower molecular weight polyether polyols may also be employed.

The alkylene oxides which may be used in the preparation of the polyol include any compound having a cyclic ether group, preferably an α,β-oxirane, and are unsubstituted or alternatively substituted with inert groups which do not chemically react under the conditions encountered in preparing a polyol. Examples of suitable alkylene oxides include ethylene oxide, propylene oxide, 1,2- or 2,3-butylene oxide, the various isomers of hexane oxide, styrene oxide, epichlorohydrin, epoxychlorohexane, epoxychloropentane and the like. Most preferred, on the basis of performance, availability and cost are ethylene oxide, propylene oxide, butylene oxide and mixtures thereof, with ethylene oxide, propylene oxide, or mixtures thereof being most preferred. If polyols are prepared with combinations of alkylene oxides, the alkylene oxides may be reacted as a complete mixture providing a random distribution of oxyalkylene units within the oxide chain of the polyol or alternatively they may be reacted in a step-wise manner so as to provide a block distribution within the oxyalkylene chain of the polyol.

The polyester polyols useful in the invention can be prepared by known procedures from a polycarboxylic acid or acid derivative, such as an anhydride or ester of the polycarboxylic acid, and a polyhydric alcohol. The acids and/or the alcohols may be used as mixtures of two or more compounds in the preparation of the polyester polyols. Polyesters having OH numbers of less than 350 mg KOH/g, more preferably less than 300 mg KOH/g are preferred for inclusion in the inventive foams.

The polycarboxylic acid component, which is preferably dibasic, may be aliphatic, cycloaliphatic, aromatic and/or heterocyclic and may optionally be substituted, for example, by halogen atoms, and/or may be unsaturated. Examples of suitable carboxylic acids and derivatives thereof for the preparation of the polyester polyols include: oxalic acid; malonic acid; succinic acid; glutaric acid; adipic acid; pimelic acid; suberic acid; azelaic acid; sebacic acid; phthalic acid; isophthalic acid; trimellitic acid; terephthalic acid; phthalic acid anhydride; tetrahydrophthalic acid anhydride; pyromellitic dianhydride; hexahydrophthalic acid anhydride; tetrachlorophthalic acid anhydride; endomethylene tetrahydrophthalic acid anhydride; glutaric acid anhydride; maleic acid; maleic acid anhydride; fumaric acid; dibasic and tribasic unsaturated fatty acids optionally mixed with monobasic unsaturated fatty acids, such as oleic acid; terephthalic acid dimethyl ester and terephthalic acid-bis-glycol ester.

Any suitable polyhydric alcohol may be used in preparing the polyester polyols. The polyols can be aliphatic, cycloaliphatic, aromatic and/or heterocyclic, and are preferably selected from the group consisting of diols, triols and tetrols. Aliphatic dihydric alcohols having no more than 20 carbon atoms are highly satisfactory. The polyols optionally may include substituents which are inert in the reaction, for example, chlorine and bromine substituents, and/or may be unsaturated. Suitable amino alcohols, such as, for example, monoethanolamine, diethanolamine, triethanolamine, or the like may also be used. Moreover, the polycarboxylic acid(s) may be condensed with a mixture of polyhydric alcohols and amino alcohols.

Examples of suitable polyhydric alcohols include, but are not limited to, ethylene glycol; propylene glycol-(1,2) and -(1,3); butylene glycol-(1,4) and -(2,3); hexane diol-(1,6); octane diol-(1,8); neopentyl glycol; 1,4-bis-hydroxymethyl cyclohexane; 2-methyl-1,3-propane diol; glycerin; trimethylolpropane; trimethylolethane; hexane triol-(1,2,6); butane triol-(1,2,4); pentaerythritol; quinitol; mannitol; sorbitol; formitol; α-methyl-glucoside; diethylene glycol; triethylene glycol; tetraethylene glycol and higher polyethyleneglycols; dipropylene glycol and higher polypropylene glycols as well as dibutylene glycol and higher polybutylene glycols. Particularly preferred are oxyalkylene glycols, such as diethylene glycol, dipropylene glycol, triethylene glycol, tripropylene glycol, tetraethylene glycol, tetrapropylene glycol, trimethylene glycol and tetramethylene glycol.

Other components useful in producing the polyurethane foams in the present invention include those known in the art such as surfactants, catalysts, pigments, colorants, fillers, antioxidants, flame retardants, stabilizers, and the like.

Spray foam formulations for pipe insulation need to be fast reacting. The foam must adhere quickly to avoid sagging or being spun off a rotating pipe. The manufacturing process of some pre-insulated pipe suppliers requires that the polyurethane foam build green strength rapidly.

The reactivity of the foam may be adjusted with catalyst level. Amine-based catalysts are used to initiate the polyurethane reaction and reduce gel time. However, a very high level of amine-based catalysts may lead to accelerated polyurethane foam decomposition reactions at elevated temperatures and therefore reduce the long-term thermal stability. The preferred catalyst in the foam of the present invention is a combination of an amine catalyst and a metal-based catalyst.

Examples of suitable tertiary amine catalysts include 1,3,5-tris(3-(dimethylamino)propyl)hexahydro-s-triazine, triethylenediamine, N-methylmorpholine, pentamethyl diethylenetriamine, dimethylcyclohexylamine, tetramethylethylenediamine, 1-methyl-4-dimethylaminoethyl-piperazine, 3-methoxy-N-dimethyl-propylamine, N-ethylmorpholine, diethylethanol-amine, N-cocomorpholine, N,N-dimethyl-N′,N′dimethylisopropyl-propylene diamine, N,N-diethyl-3-diethyl aminopropyl amine and dimethyl-benzyl amine. Examples of suitable organometallic catalysts include organomercury, organolead, organoferric and organotin catalysts, with organotin catalysts being preferred. Suitable organotin catalysts include tin salts of carboxylic acids such as dibutyltin di-2-ethyl hexanoate and dibutyltin dilaurate. Metal salts such as stannous chloride can also function as catalysts for the urethane reaction. A catalyst for the trimerization of polyisocyanates, such as an alkali metal alkoxide or carboxylate may also optionally be employed herein. Also useful are potassium salts of carboxylic acids such as potassium octoate and potassium acetate. Such catalysts are used in an amount which measurably increases the rate of reaction of the polyisocyanate. Typical amounts are 0.01 to 5.0 part of catalyst per 100 parts by weight of polyol.

When preparing polyisocyanate-based foams, it may be advantageous to employ a minor amount of a surfactant to stabilize the foaming reaction mixture until it obtains rigidity. Any suitable surfactant can be employed in the invention, including silicone/ethylene oxide/propylene oxide copolymers. Examples of surfactants useful in the present invention include, among others, polydimethylsiloxane-polyoxyalkylene block copolymers NIAX L-5420, NIAX L-5340, and NIAX Y10744 (available from GE Silicones.); DABCO DC-1 93 (from Air Products and Chemicals, Inc); and TEGOSTAB B84PI and TEGOSTAB B-8433 (from Goldschmidt Chemical Corp). Other suitable surfactants are described in U.S. Pat. Nos. 4,365,024 and 4,529,745. Other, less preferred surfactants include polyethylene glycol ethers of long chain alcohols, tertiary amine or alkanolamine salts of long chain alkyl acid sulfate esters, alkylsulfonic esters, alkylarylsulfonic acids. Such surfactants are employed in amounts sufficient to stabilize the foaming reaction mixture against collapse and the formation of large, and uneven cells. Generally, the surfactant comprises from 0.05 to 10, and preferably from 0.1 to 6, weight percent of the foam-forming composition.

The blowing agent included in the foams of the present invention contains n-pentane, cyclopentane or isopentane and optionally a minor amount of water. The blowing agent is preferably present in an amount of 2 to 12 parts by weight (pbw), based on the weight of the foam forming formulation, more preferably 3 to 8 pbw. Cyclopentane is particularly preferred as the blowing agent in the inventive foams.

### EXAMPLE

The present invention is further illustrated, but is not to be limited, by the following example. All quantities given in “parts” and “percents” are understood to be by weight, unless otherwise indicated.

High temperature cyclopentane blown rigid polyurethane spray foams were evaluated at 1:1.25 by volume polyol to isocyanate ratio (B/A). The foam formulations were hand-mixed and poured into boxes (10.5×10.5×2.5 in.). The gel time was adjusted to 15-25 seconds with chemical temperatures at 25° C. The free rise density was 3.0-4.0 lb/ft³. Foam samples were tested, as summarized below, according to ASTM test methods for core density (ASTM D 1622), Thermal Conductivity—k-factor (ASTM C 518), tensile adhesion (ASTM D 1623) and compressive strength (ASTM D 1621). Samples were also tested according European Standard EN 253: 1994 5.3.5 test method for water absorption.

Thermal stability was evaluated using a hot plate test. The test method was based on ASTM C 411-97 and ASTM C 447-85. Samples (4 ix 4 ix 2 in.) were placed directly on the hot plate surface with a steel plate on the top surface to ensure full surface contact. A pre-heated oven test, based on ASTM D 2126, was used to evaluate dimensional stability at elevated temperatures.

High Temperature Screening Test

The hot plate test described above was used to assess the performance of thermal insulating materials after exposure to a hot surface for 96 hours. The sample was examined for cracking and the depth of the cracks. ASTM C-447-85 (1995) requires that performance criteria, such as compressive strength, dimensional change, and weight loss be measured after the test.

A commercially available, thermally stable HCFC-141b foam formulation was evaluated using the hot plate test. A sample (4 ix 4 ix 2 in.) was cut, measured, weighed and placed on a hot plate pre-heated to 163° C. After 96 hours, this sample was removed, weighed, measured and examined for charring and cracking. It was noted that the sample was not cracked and there was light surface charring. The volume change was +1.5% and the weight loss was 1.3%

The hot plate test was modified by extending the duration of the test and varying the temperature to validate the use of the test as a screening tool for high temperature rigid foams. It was decided to determine the effect of time at a given temperature on the thermal stability of a rigid foam. Samples were prepared from a candidate high temperature polyurethane foam formulation and placed on a hot plate at 163° C. Samples were removed and replaced periodically so that the duration of the test ranged from 4 days to 180 days. After the samples were removed, they were weighed, measured and cut in half to determine char/discoloration depth. The samples removed after 30, 60, 90, 120, 150 and 180 days had the same char/discoloration depth, similar weight loss, and volume change, indicating that the duration of the hot plate test should be at least 30 days.

Another commercially available HCFC-141b foam, for insulating water heaters, was hot plate tested at 163° C. Water heater foams are not required to be resistant to high temperatures. After four days, the sample was removed and measured. The volume loss was about 50% with the center of the sample collapsed. This test was done to verify that the hot plate test was a viable test for evaluating rigid polyurethane high temperature foams.

The reactivity of the foam formulation was adjusted to 15-25 seconds gel time, and the free rise density was adjusted to 3.0-4.0 lb/ft³ with cyclopentane. Samples of the resultant foam were hot plate tested at 163° C. After 96 hours the samples were removed, weighed and measured. The weight loss was less than 2%. However, the volume increase was about 50%. These samples swelled, charred and cracked due to intumescence caused by the polyester polyol and flame retardant. Although intumescence is desirable when foams are flame tested during the ASTM E-84 tunnel test, it is not a desirable property of foams used for high temperature pipe insulation because intumescence can weaken the adhesion of foam to the pipe.

The following components were used in the formulation of the Example:
Polyol A a sucrose-based polyether polyol having a an OH number of about 380 mg KOH/g;
Polyol B an aromatic polyester polyol having an OH number of about 240 mg KOH/g;
Surfactant a silicon surfactant, commercially available as TEGOSTAB B-8433 from Goldschmidt Company;
Catalyst A a tertiary amine catalyst, commercially available from Air Products as POLYCAT 41;
Catalyst B a potassium acetate catalyst, commercially available from Air Products as POLYCAT 46; and
Isocyanate A a polymeric diphenylmethane diisocyanate having an NCO content of about 30.6% and a Brookfield viscosity at 25° C. of about 700 mPa·s.

The formulation of the inventive high temperature rigid polyurethane spray foam is summarized below:

EXAMPLE 1

| Component | pbw |
|---|---|
| Polyol A | 45.8 |
| Polyol B | 40.0 |
| Surfactant | 2.0 |
| Catalyst A | 3.1 |
| Catalyst B | 0.6 |
| water | 0.5 |
| cyclopentane | 8.0 |
| Isocyanate | 135 |

Due to the 1:1.25 B/A ratio requirement of the foam spraying equipment, polyesters with OH numbers less than 300 mg KOH/g were evaluated in combination with a polyether polyol using the hot plate test. A foam formulation containing a phthalic acid based polyester with a polyether polyol had good hot plate test results. The volume change was less than 10% with minimal char depth. The polyester polyol and polyether polyol ratios were varied and a polymeric MDI was chosen as the isocyanate to approach a calculated foam cross-link density of 2.6.

The combination of an amine-based and metal-based catalyst was evaluated in the inventive high temperature rigid polyurethane spray foam. The foam was analyzed using a B Scale Green Hardness Gauge. The results are summarized below in Table I.

TABLE I

| Seconds | Ex. 1 |
|---|---|
| 30 | 75 |
| 40 | 77 |
| 50 | 75 |
| 60 | 76 |
| 70 | 78 |
| 80 | 81 |
| 90 | 81 |
| 100 | 81 |
| 110 | 87 |
| 120 | 90 |
| 150 | 92 |
| 180 | 93 |

Small Scale Laboratory Test and Results

The high temperature performance of the inventive rigid polyurethane cyclopoentane blown spray foam for pipe insulation was assessed using small scale laboratory tests.

Samples were prepared from the foam. Samples were cut into blocks (4×4×in.), measured and weighed. A sample was tested for compressive strength. The samples were placed on a hot plate pre-heated to 163° C. After 30 days the samples were removed, weighed, measured and placed on the hot plate at 180° C. After another 30 days the samples were weighted, measured and placed on the hot plate at 205° C. for an additional 30 days. The samples were removed, weighed and measured. The samples were tested for compressive strength. The results are summarized below in Table II.

TABLE II

| | Ex. 1 |
|---|---|
| Initial Compressive Strength, | 62.8 |
| Parallel @10% | |
| Deflection (psi) | |
| Comp. Strength after 30 Days | 39.4 |
| @205° C., Parallel | |
| @10% Deflection (psi) | |
| Compressive Strength Retention (%) | 63 |
| Hot Plate Test, | |
| 30 Days @163° C.: | |
| Weight Change (%) | −2.8 |
| Volume Change (%) | 1.3 |
| Hot Plate Test, additional | |
| 30 Days @180° C. | |
| Weight Change (%) | −4.4 |
| Volume Change (%) | 0.5 |
| Hot Plate Test, additional | |
| 30 Days @205° C. | |
| Weight Change (%) | −6.5 |
| Volume Change (%) | 2.2 |

Samples of the foam were made in test boxes for an oven-aging test. The polyurethane foam formulations were also foamed on schedule 40 steel coupons that were pre-heated to 115-120° F. for tensile adhesion testing. Core foam samples were measured and weighed and placed in a pre-heated oven at 170° C. Samples that were foamed on the steel plates were also placed in the oven. After 77 days at 170° C., the samples were removed, weighed, measured and tested for compressive strength. Tensile adhesion was tested after 50 days. The results are summarized below in Table III.

Tensile adhesion was also tested on samples that were hot plate tested at 150° C. for 50 days. These results are also included in Table III. The tensile adhesion failure of the 170° C. samples was foam to foam.

TABLE III

| | Ex. 1 |
|---|---|
| Compressive Strength | |
| Compressive Strength (before) | |
| 5% | 71.4 |
| 10% | 68.0 |
| Yield | 76.9 |
| Compressive Strength | |
| (after 77 days @170° C.) | |
| 5% | 14.5 |
| 10% | 24.7 |
| Yield | 2.1 |
| % Retention @10% | 36.3 |
| Tensile Adhesion Strength | |
| Tensile Adhesion Strength (before) | 44.3 |
| Tensile Adhesion Strength | 14.1 |
| (after 50 days @170° C.) | |
| % Retention | 31.8 |
| Tensile Adhesion Strength | 26.7 |
| (after 50 days @150° C.) | |
| % Retention | 60.3 |
| Oven Test | |
| Oven Test (28 days @170° C.) | |
| Volume Change (%) | 11.0 |
| Weight Change (%) | −12.9 |
| Oven Test (77 days @170° C.) | |
| Volume Change (%) | 1.8 |
| Weight Change (%) | −21.6 |

Samples from the inventive foam were cut into blocks (7×7×2 in.), weighed, measured and tested for k-factor. Samples were also tested for compressive strength. The samples were placed on a hot plate pre-heated to 1500C. The samples were removed every seven days, weighed and tested for k-factor. The percent weight loss and k-factors are presented in Table IV-A below.

TABLE IV-A

Ex. 1

| Days | k-factor | Wt. Loss (%) |
|---|---|---|
| 0 | 0.161 | 0.00 |
| 1 | 0.171 | 0.60 |
| 7 | 0.182 | 1.45 |
| 14 | 0.187 | 1.70 |
| 21 | 0.189 | 2.00 |
| 28 | 0.194 | 2.10 |
| 35 | 0.195 | 2.50 |
| 42 | 0.195 | 2.70 |
| 49 | 0.197 | 2.90 |
| 56 | 0.199 | 2.96 |
| 63 | 0.200 | 3.21 |
| 70 | 0.201 | 3.87 |
| 77 | 0.199 | 3.83 |
| 84 | 0.201 | 4.17 |
| 91 | 0.202 | 4.48 |

After 91 days the samples were removed and tested for compressive strength (Table IV-B). The samples were inspected for char depth and cracking. The extent of the discoloration for the foam was about 30% of the original thickness.

TABLE IV-B

| | Ex. 1 |
|---|---|
| Initial Compressive Strength, | 68.0 |
| Parallel @10% Deflection (psi) | |
| Comp. Strength after 91 Days @150° C., | 47.2 |
| Parallel @10% Deflection (psi) | |
| Compressive Strength Retention (%) | 69 |
| Volume Change (%) | 2.4 |
| Weight Change (%) | −4.5 |

Samples of the foam were tested for water absorption using the EN 253. 1994 5.3.5 test procedure. The results are summarized below in Table V.

TABLE V

| Test No. | Water absorption (%) |
|---|---|
| 1 | 4.1 |
| 2 | 4.3 |
| 3 | 3.8 |
| Average | 4.1 |

The foregoing example of the present invention is offered for the purpose of illustration and not limitation. It will be apparent to those skilled in the art that the embodiment described herein may be modified or revised in various ways without departing from the spirit and scope of the invention. The scope of the invention is to be measured by the appended claims.

What is claimed is:

1. A rigid polyurethane foam comprising the reaction product of:
a polyol component comprising,
about 70% to about 40% by weight, based on the weight of the polyol component, of at least one polyether polyol, and
about 30% to about 60% by weight, based on the weight of the polyol component, of at least one polyester polyol having an OH number of less than about 350 mg KOH/g; with
at least one isocyanate, at a polyol component to isocyanate ratio of about 1:1.25 by volume,
in the presence of a blowing agent chosen from n-pentane, isopentane and cyclopentane, and optionally, in the presence of at least one of catalysts, fillers, additives and surfactants,
wherein the rigid polyurethane foam has a cross linking density of less than about 2.6.

2. The rigid polyurethane foam according to claim 1, wherein the at least one isocyanate is chosen from aromatic polyisocyanates, aliphatic polyisocyanates, cycloaliphatic polyisocyanates and combinations thereof.

3. The rigid polyurethane foam according to claim 1, wherein the at least one isocyanate is chosen from m-phenylene diisocyanate, toluene-2,4-diisocyanate, toluene-2,6-diisocyanate, mixtures of 2,4- and 2,6-toluene diisocyanate, hexamethylene-1,6-diisocyanate, tetramethylene-1,4-diisocyanate, cyclohexane-1,4-diisocyanate, hexahydrotoluene 2,4- and 2,6-diisocyanate, naphthalene-1,5-diisocyanate, 4,4′-diphenylmethane diisocyanate (MDI), polymeric MDI (PMDI), prepolymers of PMDI, 4,4′-diphenylenediisocyanate, 3,3′-dimethoxy-4,4′-biphenyl-diisocyanate, 3,3′-dimethyldiphenylmethane-4,4′-diisocyanate; 4,4′,4′-triphenylmethane-triisocyanate, polymethylenepolyphenyl isocyanate, toluene-2,4,6-triisocyanate and 4,4′-dimethyldiphenylmethane-2,2′,5,5′-tetraisocyanate.

4. The rigid polyurethane foam according to claim 1, wherein the at least one isocyanate is chosen from polymeric MDI (PMDI) and a prepolymer of PMDI.

5. The rigid polyurethane foam according to claim 1, wherein the at least one polyether polyol is based on sucrose or sorbitol.

6. The rigid polyurethane foam according to claim 1, wherein the at least one polyester polyol is based on a polycarboxylic acid chosen from oxalic acid, malonic acid, succinic acid, glutaric acid, adipic acid, pimelic acid, suberic acid, azelaic acid, sebacic acid, phthalic acid, isophthalic acid, trimellitic acid, terephthalic acid, phthalic acid anhydride, tetrahydrophthalic acid anhydride, pyromellitic dianhydride, hexahydrophthalic acid anhydride, tetrachlorophthalic acid anhydride, endomethylene tetrahydrophthalic acid anhydride, glutaric acid anhydride, maleic acid, maleic acid anhydride and fumaric acid.

7. The rigid polyurethane foam according to claim 1, wherein the at least one polyester polyol is based on phthalic acid or phthalic acid anhydride.

8. The rigid polyurethane foam according to claim 1, wherein the at least one polyester polyol is based on a polyalcohol chosen from ethylene glycol, propylene glycol-(1,2) and -(1,3), butylene glycol-(1,4) and -(2,3), hexane diol-(1,6), octane diol-(1,8), neopentyl glycol, 1,4-bis-hydroxymethyl cyclohexane, 2-methyl-1,3-propane diol, glycerin, trimethylolpropane, trimethylolethane, hexane triol-(1,2,6), butane triol-(1,2,4), pentaerythritol, quinitol, mannitol, sorbitol, formitol, α-methyl-glucoside, diethylene glycol, triethylene glycol, tetraethylene glycol, dibutylene glycol, diethylene glycol, dipropylene glycol, triethylene glycol, tripropylene glycol, tetraethylene glycol, tetrapropylene glycol, trimethylene glycol and tetramethylene glycol.

9. The rigid polyurethane foam according to claim 1, wherein the at least one polyester polyol has an OH number of about 300 mg KOH/g or less.

10. The rigid polyurethane foam according to claim 1, wherein the catalyst is at least one of 1,3,5-tris(3-(dimethylamino)propyl)hexahydro-s-triazine, triethylenediamine, N-methylmorpholine, pentamethyl diethylenetriamine, dimethylcyclohexylamine, tetramethylethylenediamine, 1-methyl-4-dimethylaminoethyl-piperazine, 3-methoxy-N-dimethyl-propylamine, N-ethylmorpholine, diethylethanol-amine, N-cocomorpholine, N,N-dimethyl-N′,N′dimethylisopropyl-propylene diamine, N,N-diethyl-3-diethyl aminopropyl amine, dimethyl-benzyl amine, dibutyltin di-2-ethyl hexanoate, dibutyltin dilaurate, stannous chloride, potassium octoate and potassium acetate.

11. The rigid polyurethane foam according to claim 1, wherein the blowing agent comprises n-pentane.

12. The rigid polyurethane foam according to claim 1, wherein the blowing agent comprises cyclopentane.

13. The rigid polyurethane foam according to claim 1, wherein the foam is capable of withstanding temperatures of about 250 to about 350° F. for at least about 30 days and maintaining structural integrity.

14. A pipe insulated with the rigid polyurethane foam according to claim 1.

15. A process for making a rigid polyurethane foam comprising reacting:
a polyol component comprising,
about 70% to about 40% by weight, based on the weight of the polyol component, of at least one polyether polyol, and
about 30% to about 60% by weight, based on the weight of the polyol component, of at least one polyester polyol having an OH number of less than about 350 mg KOH/g; with
at least one isocyanate, at a polyol component to isocyanate ratio of about 1:1.25 by volume,
in the presence of a blowing agent chosen from n-pentane, isopentane and cyclopentane, and optionally, in the presence of at least one of catalysts, fillers, additives and surfactants,
wherein the rigid polyurethane foam has a cross linking density of less than about 2.6.

16. The process according to claim 15, wherein the at least one isocyanate is chosen from aromatic polyisocyanates, aliphatic polyisocyanates, cycloaliphatic polyisocyanates and combinations thereof.

17. The process according to claim 15, wherein the at least one isocyanate is chosen from m-phenylene diisocyanate, toluene-2,4-diisocyanate, toluene-2,6-diisocyanate, mixtures of 2,4- and 2,6-toluene diisocyanate, hexamethylene-1,6-diisocyanate, tetramethylene-1,4-diisocyanate, cyclohexane-1,4-diisocyanate, hexahydrotoluene 2,4- and 2,6-diisocyanate, naphthalene-1,5-diisocyanate, 4,4′-diphenylmethane diisocyanate (MDI), polymeric MDI (PMDI), prepolymers of PMDI, 4,4′-diphenylenediisocyanate, 3,3′-dimethoxy-4,4′-biphenyl-diisocyanate, 3,3′-dimethyldiphenylmethane-4,4′-diisocyanate; 4,4′,4′-triphenylmethane-triisocyanate, polymethylenepolyphenyl isocyanate, toluene-2,4,6-triisocyanate and 4,4′-dimethyldiphenylmethane-2,2′,5,5′-tetraisocyanate.

18. The process according to claim 15, wherein the at least one isocyanate is chosen from polymeric MDI (PMDI) and a prepolymer of PMDI.

19. The process according to claim 15, wherein the at least one polyether polyol is based on sucrose or sorbitol.

20. The process according to claim 15, wherein the at least one polyester polyol is based on a polycarboxylic acid chosen from oxalic acid, malonic acid, succinic acid, glutaric acid, adipic acid, pimelic acid, suberic acid, azelaic acid, sebacic acid, phthalic acid, isophthalic acid, trimellitic acid, terephthalic acid, phthalic acid anhydride, tetrahydrophthalic acid anhydride, pyromellitic dianhydride, hexahydrophthalic acid anhydride, tetrachlorophthalic acid anhydride, endomethylene tetrahydrophthalic acid anhydride, glutaric acid anhydride, maleic acid, maleic acid anhydride and fumaric acid.

21. The process according to claim 15, wherein the at least one polyester polyol is based on phthalic acid or phthalic acid anhydride.

22. The process according to claim 15, wherein the at least one polyester polyol is based on a polyalcohol chosen from ethylene glycol, propylene glycol-(1,2) and -(1,3), butylene glycol-(1,4) and -(2,3), hexane diol-(1,6), octane diol-(1,8), neopentyl glycol, 1,4-bis-hydroxymethyl cyclohexane, 2-methyl-1,3-propane diol, glycerin, trimethylolpropane, trimethylolethane, hexane triol-(1,2,6), butane triol-(1,2,4), pentaerythritol, quinitol, mannitol, sorbitol, formitol, α-methyl-glucoside, diethylene glycol, triethylene glycol, tetraethylene glycol, dibutylene glycol, diethylene glycol, dipropylene glycol, triethylene glycol, tripropylene glycol, tetraethylene glycol, tetrapropylene glycol, trimethylene glycol and tetramethylene glycol.

23. The process according to claim 15, wherein the at least one polyester polyol has an OH number of about 300 mg KOH/g or less.

24. The process according to claim 15, wherein the catalyst is at least one of 1,3,5-tris(3-(dimethylamino)propyl)hexahydro-s-triazine, triethylenediamine, N-methylmorpholine, pentamethyl diethylenetriamine, dimethylcyclohexylamine, tetramethylethylenediamine, 1-methyl-4-dimethylaminoethyl-piperazine, 3-methoxy-N-dimethyl-propylamine, N-ethylmorpholine, diethylethanol-amine, N-cocomorpholine, N,N-dimethyl-N′,N′dimethylisopropyl-propylene diamine, N,N-diethyl-3-diethyl aminopropyl amine, dimethyl-benzyl amine, dibutyltin di-2-ethyl hexanoate, dibutyltin dilaurate, stannous chloride, potassium octoate and potassium acetate.

25. The process according to claim 15, wherein the blowing agent comprises n-pentane.

26. The process according to claim 15, wherein the blowing agent comprises cyclopentane.

27. A pipe insulated with the rigid polyurethane foam made by the process according to claim 15.

28. A process for insulating a pipe comprising spraying onto the pipe a rigid polyurethane foam comprising the reaction product of:
a polyol component comprising,
about 70% to about 40% by weight, based on the weight of the polyol component, of at least one polyether polyol, and
about 30% to about 60% by weight, based on the weight of the polyol component, of at least one polyester polyol having an OH number of less than about 350 mg KOH/g; with
at least one isocyanate, at a polyol component to isocyanate ratio of about 1:1.25 by volume,
in the presence of a blowing agent chosen from n-pentane, isopentane and cyclopentane, and optionally, in the presence of at least one of catalysts, fillers, additives and surfactants,
wherein the rigid polyurethane foam has a cross linking density of less than about 2.6.

29. The process according to claim 28, wherein the at least one isocyanate is chosen from aromatic polyisocyanates, aliphatic polyisocyanates, cycloaliphatic polyisocyanates and combinations thereof.

30. The process according to claim 28, wherein the at least one isocyanate is chosen from m-phenylene diisocyanate, toluene-2,4-diisocyanate, toluene-2,6-diisocyanate, mixtures of 2,4- and 2,6-toluene diisocyanate, hexamethylene-1,6-diisocyanate, tetramethylene-1,4-diisocyanate, cyclohexane-1,4-diisocyanate, hexahydrotoluene 2,4- and 2,6-diisocyanate, naphthalene-1,5-diisocyanate, 4,4′-diphenylmethane diisocyanate (MDI), polymeric MDI (PMDI), prepolymers of PMDI, 4,4′-diphenylenediisocyanate, 3,3′-dimethoxy-4,4′-biphenyl-diisocyanate, 3,3′-dimethyldiphenylmethane-4,4′-diisocyanate; 4,4′,4′-triphenylmethane-triisocyanate, polymethylenepolyphenyl isocyanate, toluene-2,4,6-triisocyanate and 4,4′-dimethyldiphenylmethane-2,2′,5,5′-tetraisocyanate.

31. The process according to claim 28, wherein the at least one isocyanate is chosen from polymeric MDI (PMDI) and a prepolymer of PMDI.

32. The process according to claim 28, wherein the at least one polyether polyol is based on sucrose or sorbitol.

33. The process according to claim 28, wherein the at least one polyester polyol is based on a polycarboxylic acid chosen from oxalic acid, malonic acid, succinic acid, glutaric acid, adipic acid, pimelic acid, suberic acid, azelaic acid, sebacic acid, phthalic acid, isophthalic acid, trimellitic acid, terephthalic acid, phthalic acid anhydride, tetrahydrophthalic acid anhydride, pyromellitic dianhydride, hexahydrophthalic acid anhydride, tetrachlorophthalic acid anhydride, endomethylene tetrahydrophthalic acid anhydride, glutaric acid anhydride, maleic acid, maleic acid anhydride and fumaric acid.

34. The process according to claim 28, wherein the at least one polyester polyol is based on phthalic acid or phthalic acid anhydride.

35. The process according to claim 28, wherein the at least one polyester polyol is based on a polyalcohol chosen from ethylene glycol, propylene glycol-(1,2) and -(1,3), butylene glycol-(1,4) and -(2,3), hexane diol-(1,6), octane diol-(1,8), neopentyl glycol, 1,4-bis-hydroxymethyl cyclohexane, 2-methyl-1,3-propane diol, glycerin, trimethylolpropane, trimethylolethane, hexane triol-(1,2,6), butane triol-(1,2,4), pentaerythritol, quinitol, mannitol, sorbitol, formitol, α-methyl-glucoside, diethylene glycol, triethylene glycol, tetraethylene glycol, dibutylene glycol, diethylene glycol, dipropylene glycol, triethylene glycol, tripropylene glycol, tetraethylene glycol, tetrapropylene glycol, trimethylene glycol and tetramethylene glycol.

36. The process according to claim 28, wherein the at least one polyester polyol has an OH number of about 300 mg KOH/g or less.

37. The process according to claim 28, wherein the catalyst is at least one of 1,3,5-tris(3-(dimethylamino)propyl)hexahydro-s-triazine, triethylenediamine, N-methylmorpholine, pentamethyl diethylenetriamine, dimethylcyclohexylamine, tetramethylethylenediamine, 1-methyl-4-dimethylaminoethyl-piperazine, 3-methoxy-N-dimethyl-propylamine, N-ethylmorpholine, diethylethanol-amine, N-cocomorpholine, N,N-dimethyl-N′,N′dimethylisopropyl-propylene diamine, N,N-diethyl-3-diethyl aminopropyl amine, dimethyl-benzyl amine, dibutyltin di-2-ethyl hexanoate, dibutyltin dilaurate, stannous chloride, potassium octoate and potassium acetate.

38. A pipe insulated with rigid polyurethane foam by the process according to claim 28.
